(19) United States
(12) Patent Application Publication
(10) Pub. No.: US 2011/0252617 A1
(43) Pub. Date: Oct. 20, 2011

(54) Clinch Joint

(75) Inventors: Brian Swetlic, Arvada, CO (US); Matthew Bush, Evergreen, CO (US)

(73) Assignee: BAND-IT-IDEX, INC., Denver, CO (US)

(21) Appl. No.: 13/087,241

(22) Filed: Apr. 14, 2011

Related U.S. Application Data
(60) Provisional application No. 61/324,244, filed on Apr. 14, 2010.

(51) Int. Cl. B23P 19/04

(52) U.S. Cl. 29/237

(57) ABSTRACT

A system of joining two tubes is provided. More specifically, a node is formed on an end of an inner tube that is received within an outer tube. A portion of the outer tube is then deflected into the indent such that the outer tube matingly engages the inner tube. The force required to deflect the portion of the outer tube into the inner tube is provided by tensioning a band clamp positioned around the outer tube.

This application claims the benefit of U.S. Provisional Patent Application No. 61/324,244, filed Apr. 14, 2010, the entire disclosure of which is incorporated by reference herein. This application is also related to U.S. patent application Ser. No. 12/264,086, U.S. Pat. No. 5,483,998, U.S. patent application Ser. No. 12/628,943, U.S. Pat. No. 4,896,402, and U.S. Pat. No. 6,014,792, the entire disclosureS of which are incorporated by reference herein.

### FIELD OF THE INVENTION

A system is provided that facilitates the joining of two members. The system may be used in the automotive, aerospace, HVAC industries, to name a few.

### BACKGROUND OF THE INVENTION

It is sometimes desirous to interconnect tubes together by way of nodes. For example, in the manufacture of automobiles, steel nodes (high strength and stiffness) are used to connect aluminum tubes (low weight). One process for interconnecting the tubes to nodes comprises magnetic pulse crimping which places high circumferential pressures on a joint to deform an aluminum outer tube over a specifically designed form of the internally-disposed steel node. However, this approach has many problems. Most notably, the crimping equipment is expensive (˜$1 M for the power supply).

### SUMMARY OF THE INVENTION

The node of one embodiment, which is defined by an indentation in an inner tube, which may be cylindrical, prismatic, etc. In operation the node is received into a tube that is clamped to the node using a band clamp produced by Band-It IDEX, some of which are identified above. The band is tensioned and deforms part of the outer tube into the indentation provided by the node which interconnect the tube to the node. The outer tube may be cylindrical, prismatic, etc. and may correspond to the shape of the node. The node facilitates interconnection of tubes of dissimilar materials. Further, the node may be part of another structure.

The clinch joint of one embodiment of the present invention has the following performance characteristics:

| | | | | | Effective clamp | Effective clamp | Ultimate | Ultimate |
|---|---|---|---|---|---|---|---|---|
| Max | Max | Estimated | Estimated | | strength, | strength, | Loop | Loop |
| Clamping | Clamping | Retained | Retained | | point of | point of | Tensile | Tensile |
| force (lbs) | force (N) | force (lbs) | force (N) | % Retained | yield (lbs) | yield (N) | (lbs) | (N) |
| 6,071 | 27,004 | 5,394 | 23,993 | 89% | 12,869 | 57,241 | ~20,000 | ~90,000 |

Wherein “max clamping force” is the peak clamping force measured prior to cutoff, “retained force” is the force measured after clamp cutoff, and “loop tensile force is the force required to separate the lock of a clamp.

The Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1A is a front elevation view of a node of one embodiment of the present invention;

FIG. 1B is a left elevation view of FIG. 1A showing an interconnected cap;

FIG. 1C is a right elevation view of FIG. 1A;

FIG. 2 is an exploded perspective view of the node prior to interconnection to an outer tube;

FIG. 3 is a perspective view of an outer tube interconnected to a node;

FIG. 4 is a perspective view of the interconnected inner and outer tubes wherein a clamp has been removed;

FIG. 5 is an exploded perspective view of another embodiment of the present invention that employs an outer tube having a plurality of windows;

FIG. 6 is a partial perspective view of the interconnection scheme of FIG. 5; and

FIG. 7 is a partial perspective view similar to that of FIG. 6 wherein the outer tube has been interconnected to the node and the band clamp has been removed.

To assist in the understanding of one embodiment of the present invention the following list of components and associated numbering found in the drawings is provided herein:

| # | Components |
|---|---|
| 2 | Node |
| 4 | Cap |
| 6 | Indent |
| 8 | Inner Tube |
| 10 | Outer Tube |
| 14 | Clamp |
| 18 | Crimp |
| 22 | Windows |

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

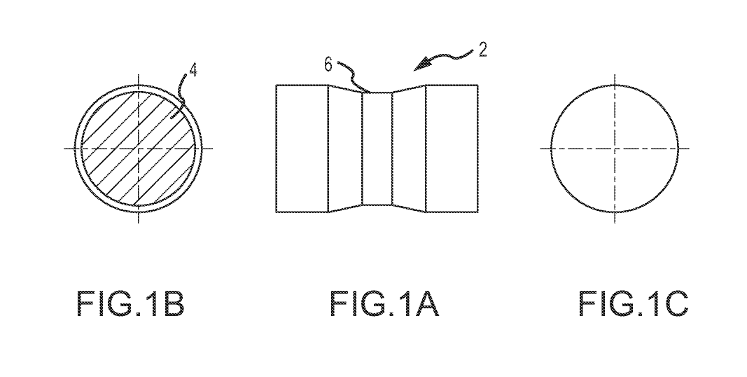

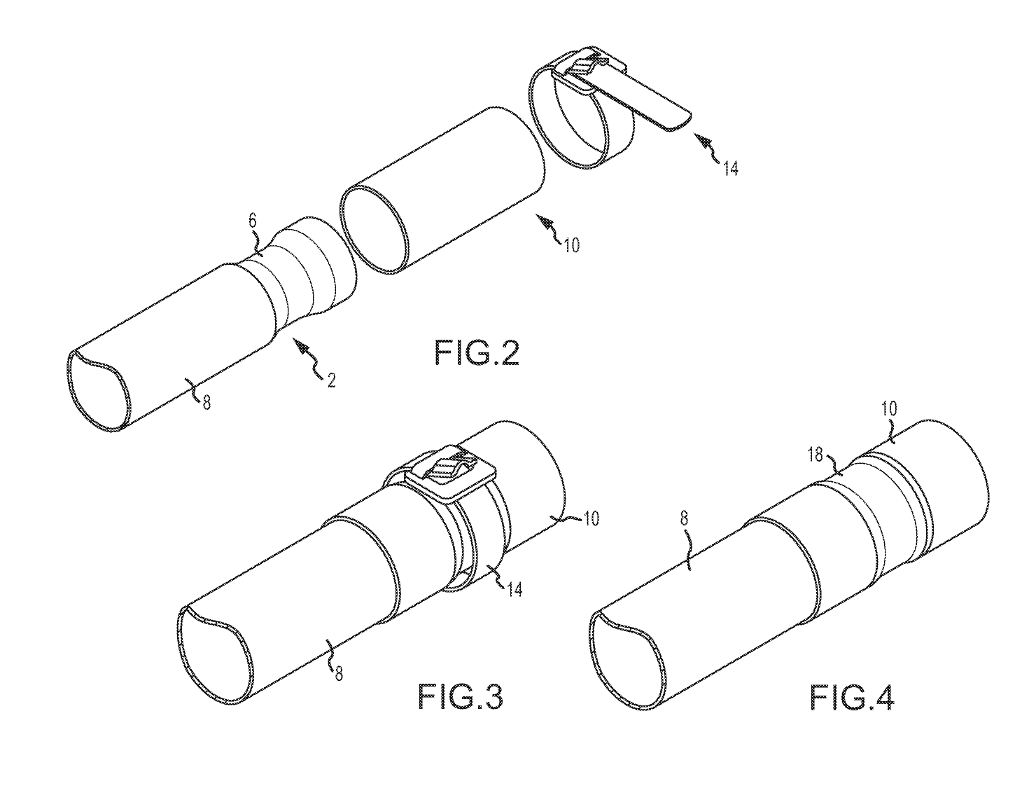

Referring now to FIGS. 1-4, interconnection of tubes using a node 2 is shown. More specifically, embodiments of the present invention contemplate the interconnection of an inner tube 8 to an outer tube 10. In operation, the inner tube 8 includes an end with a node 2 that is comprised of an indented 6 portion of the inner tube 8.

In operation, the outer tube 10 is placed over the inner tube 8 wherein the indent 6 is located within the inner volume of the outer tube 10. Next, a clamp 14 is placed about the outer tube 10 and over the indent and a sufficient clamping force is applied that deforms a portion of the outer tube 10 to form a crimp 18 that mates with the indent. The crimp 18/indent 6 relationship prohibits relative axial movement between the inner tube 8 and the outer tube 10. After the two tubes are interconnected, the clamp 14 may be removed as shown in FIG. 4.

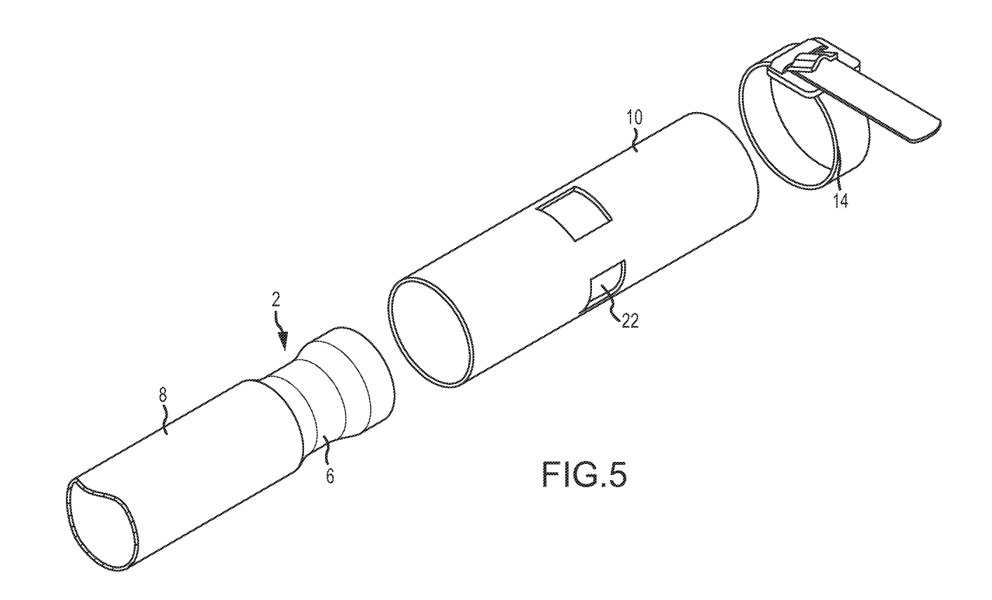

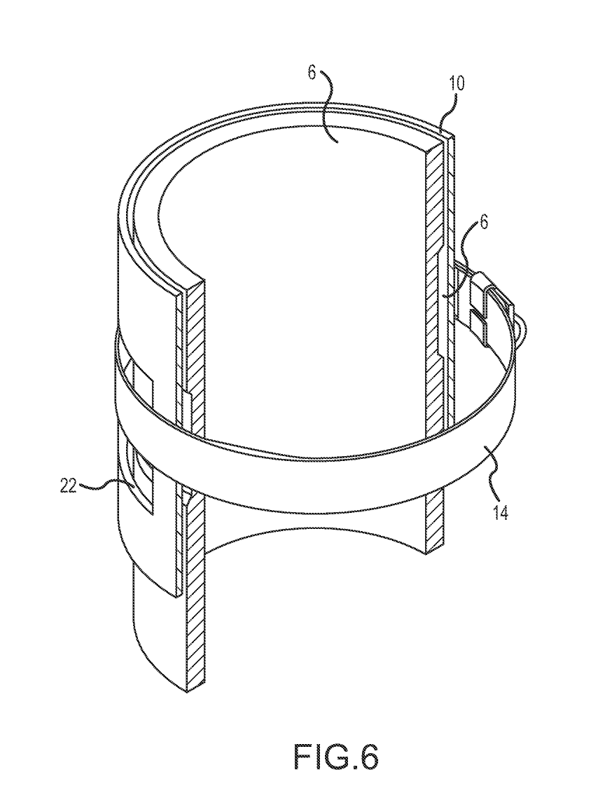

FIGS. 5-7 show another method of interconnection wherein the outer tube 10 includes a plurality of windows 22. The windows 22 help align the outer tube 10 over the inner tube 8. In addition, the windows 22 ensure that a predetermined portion of the outer tube 10 is located over the indent 6. The windows 22 also facilitate deformation of the outer tube 10 into the indent 6.

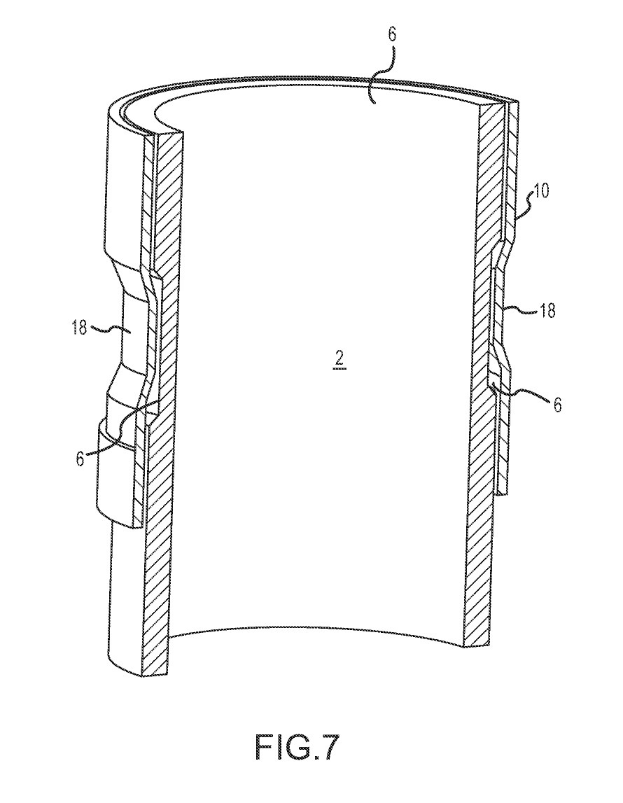

In operation, once the outer tube 10 is aligned over the inner tube 8 and the windows 22 are placed approximately over the indent 6, the band clamp 14 is placed over the windows 22. The band clamp 14 is then tensioned, thereby deforming portions of the outer tube 10 into the indent 6 such that the crimp 18 forms a mating engagement with the indent 6, which prevents axial movement of the outer tube 10 relative to the inner tube 8. Again, as shown in FIG. 7, the clamp 14 may then be removed from the outer tube 8.

While various embodiments of the present invention have been described in detail, it is apparent that modifications and alterations of those embodiments will occur to those skilled in the art. Moreover, references made herein to “the present invention” or aspects thereof should be understood to mean certain embodiments of the present invention and should not necessarily be construed as limiting all embodiments to a particular description. However, it is to be expressly understood that such modifications and alterations are within the scope and spirit of the present invention, as set forth in the following claims.

What is claimed is:

1. A system for joining a node to a tube, comprising:
a node having a circumferential indentation;
a tube for positioning over said indentation; and
a band positioned over said tube wherein said tube is deformed into said indentation by said band to secure said tube to said node.
